(19) United States
(12) Patent Application Publication
(10) Pub. No.: US 2011/0307923 A1
(43) Pub. Date: Dec. 15, 2011

(54) IMAGE PROCESSING APPARATUS, METHOD, AND PROGRAM

(75) Inventors: Kouzi Nishimura, Tokyo (JP); Yasunari Hatasawa, Tokyo (JP); Goh Kobayashi, Tokyo (JP); Hiroshi Kobayashi, Kanagawa (JP); Kensaku Ishizuka, Tokyo (JP)

(73) Assignees: Sony Computer Entertainment Inc., Tokyo (JP); Sony Corporation, Tokyo (JP)

(21) Appl. No.: 13/150,315

(22) Filed: Jun. 1, 2011

(30) Foreign Application Priority Data
Jun. 9, 2010 (JP) 2010-132455

(51) Int. Cl. H04N 5/445

(52) U.S. Cl. 725/40

(57) ABSTRACT

There is provided an image processing apparatus including a genre information retrieval section retrieving genre information about a program, an image quality control signal generation section generating an image quality control signal for controlling image quality of an image in the program on the basis of the genre information retrieved by the genre information retrieval section, and an image quality control section controlling the image quality of the image in the program on the basis of the image quality control signal generated by the image quality control signal generation section.

### BACKGROUND

The present disclosure relates to an image processing apparatus, a method, and a program, and more particularly, to an image processing apparatus, a method, and a program for appropriately improving image quality of an image on the basis of genre information about a program.

In recent years, a technique for improving image quality of a broadcast program has been suggested. In this technique, genre information about the program is obtained from EPG (Electronic Program Guide) information, and the image quality is improved on the basis of the obtained genre information (see Japanese Patent Application Laid-Open No. 2008-295023).

### SUMMARY

By the way, when a program includes a plurality of contents, a plurality of pieces of genre information may be obtained from the EPG. When the technique suggested in Japanese Patent Application Laid-Open No. 2008-295023 is used in this case, a piece of genre information written at the head of the plurality of pieces of genre information is selected, or even when an order of precedence is defined in advance, a piece of genre information having the highest order of precedence is selected.

In other words, when the technique suggested in Japanese Patent Application Laid-Open No. 2008-295023 is used, only one piece of genre information among the plurality of pieces of genre information is selected in either case. Therefore, when a piece of genre information at the head is selected, selection is made as follows. For example, when the first half of the content includes a content of an animation program, and the latter half of the content includes a content of a sports program, a piece of genre information indicating the animation program is selected.

For example, when noise reduction is considered as an example of processing for improving image quality, a filter processing having a high degree of noise reduction effect is applied to the entire content since an animation is generally an image including many contour lines. Therefore, noise reduction is appropriately applied to the first half, i.e., the animation program.

However, in the latter half, i.e., the sports program, fast-moving images are processed by the filter having the high degree of noise reduction effect, which generally causes a processing error called tail-like noise.

As described above, when the content including the plurality of pieces of genre information is subjected to the image quality improvement processing on the basis of one of the pieces of genre information, the image quality improvement processing may fail in the program of the unselected piece of genre information.

In light of the foregoing, it is desirable to realize appropriate image quality improvement processing with genre information even when a plurality of pieces of genre information are included in a content.

According to an embodiment of the present disclosure, there is provided an image processing apparatus which includes a genre information retrieval section retrieving genre information about a program, an image quality control signal generation section generating an image quality control signal for controlling image quality of an image in the program on the basis of the genre information retrieved by the genre information retrieval section, and an image quality control section controlling the image quality of the image in the program on the basis of the image quality control signal generated by the image quality control signal generation section.

The genre information retrieval section may retrieve not only the genre information but also related data about the image in the program, and the image quality control signal generation section may generate the image quality control signal for controlling image quality of the image in the program on the basis of not only the genre information but also the related data about the image in the program retrieved by the genre information retrieval section.

The image quality control signal generation section may include a noise reduction processing control signal generation section generating a noise reduction processing control signal representing an intensity of processing for removing noise on the basis of the genre information, and the image quality control section may include a noise reduction processing section executing the processing for removing, at the intensity based on the noise reduction processing control signal, noise in the image quality of the image in the program.

The image quality control signal generation section may include a pull-down detection processing control signal generation section generating a pull-down detection processing control signal for limiting a pull-down pattern to be detected, when the pull-down pattern is detected on the basis of the genre information from the image in the program; and an IP conversion processing control signal generation section generating, on the basis of the genre information, an IP conversion processing control signal including a parameter indicating whether IP conversion is performed after inverse transformation is performed with the pull-down pattern of the image or the IP conversion is performed without performing the inverse transformation when IP conversion processing is performed on the image in the program. The image quality control section may include a pull-down detection processing section detecting the pull-down pattern of the image in the program using the pull-down pattern limited on the basis of the pull-down detection processing control signal, and an IP conversion processing section performing the IP conversion on the image in the program without performing the inverse transformation or upon performing the inverse transformation on the image with the pull-down pattern detected by the pull-down detection processing section on the basis of the IP conversion processing control signal.

The image quality control signal generation section may include a scaling processing control signal generation section generating, on the basis of the genre information, a scaling processing control signal for controlling a threshold value used for reliability evaluation of interpolation/generation of a pixel of the image in the program in an edge direction. The image quality control section may include a scaling processing section interpolating/generating, on the basis of the scaling processing control signal, a pixel in question using a pixel residing in an edge direction in which the reliability evaluation is higher than the threshold value from among edge directions of the image in the program.

The image quality control signal generation section may include an enhancing processing control signal generation section generating, on the basis of the genre information, an enhancing processing control signal for controlling an intensity of the enhancing processing performed on the image in the program, and

the image quality control section includes an enhancing processing section performing enhancing processing on the image in the program at the intensity based on the enhancing processing control signal.

According to another embodiment of the present disclosure, there is provided an image processing method for an image processing apparatus which includes a genre information retrieval section retrieving genre information about a program, an image quality control signal generation section generating an image quality control signal for controlling image quality of an image in the program on the basis of the genre information retrieved by the genre information retrieval section, and an image quality control section controlling the image quality of the image in the program on the basis of the image quality control signal generated by the image quality control signal generation section. The image processing method may include causing the genre information retrieval section to retrieve the genre information about the program, causing the image quality control signal generation section to generate the image quality control signal for controlling the image quality of the image in the program on the basis of the genre information retrieved by the genre information retrieval section, and causing the image quality control section to control the image quality of the image in the program on the basis of the image quality control signal generated by the image quality control signal generation section.

According to another embodiment of the present disclosure, there is provided a program for a computer controlling an image processing apparatus which includes a genre information retrieval section retrieving genre information about a program, an image quality control signal generation section generating an image quality control signal for controlling image quality of an image in the program on the basis of the genre information retrieved by the genre information retrieval section, and an image quality control section controlling the image quality of the image in the program on the basis of the image quality control signal generated by the image quality control signal generation section. The program may cause the computer to execute causing the genre information retrieval section to retrieve the genre information about the program, causing the image quality control signal generation section to generate the image quality control signal for controlling the image quality of the image in the program on the basis of the genre information retrieved by the genre information retrieval section, and causing the image quality control section to control the image quality of the image in the program on the basis of the image quality control signal generated by the image quality control signal generation section.

According to one aspect of the present disclosure, genre information about a program is obtained, and an image quality control signal for controlling the image quality of the image in the program is generated on the basis of the obtained genre information. Then, the image quality of the image in the program is controlled on the basis of the generated image quality control signal.

The image processing apparatus according to the present disclosure may be an independent apparatus or may be a block for performing image processing.

According to one aspect of the present disclosure, the image in the program can be converted into a high quality image on the basis of the genre of the program.

### BRIEF DESCRIPTION OF THE DRAWINGS

FIG. 1 is a block diagram illustrating an example of a configuration of an embodiment of an image processing apparatus according to the present disclosure;

FIG. 2 is a diagram illustrating an example of a configuration of an image processing unit;

FIG. 3 is a flowchart illustrating image processing;

FIG. 4 is a flowchart illustrating image quality control information generation processing;

FIG. 5 is a flowchart illustrating analysis processing;

FIG. 6 is a diagram illustrating a white list and a black list;

FIG. 7 is a flowchart illustrating image quality improvement processing;

FIG. 8 is a diagram illustrating image quality improvement processing; and

FIG. 9 is a diagram illustrating an example of a configuration of a general-purpose personal computer.

### DETAILED DESCRIPTION OF THE EMBODIMENT

### Example of Configuration of Image Processing Apparatus

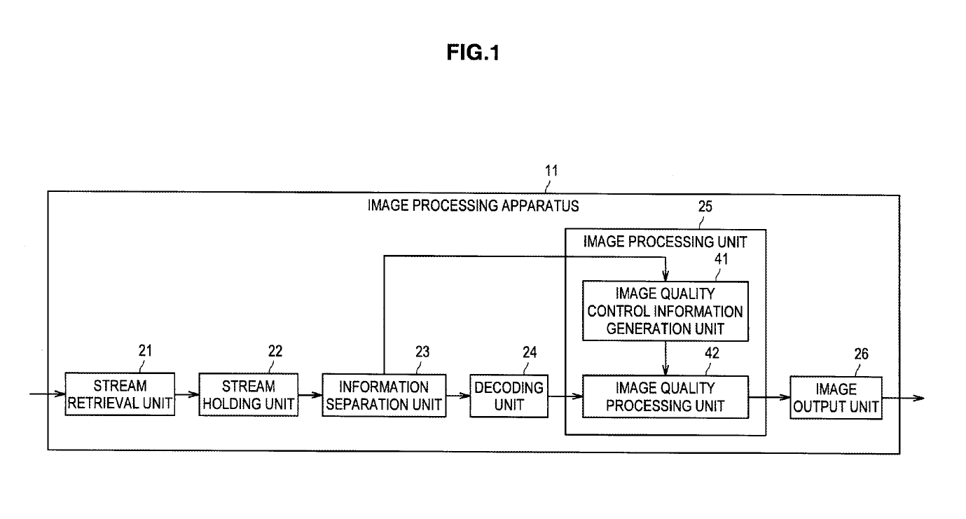

FIG. 1 illustrates an example of a configuration of an embodiment of hardware of an image processing apparatus according to the present disclosure. An image processing apparatus 11 shown in FIG. 1 appropriately improves image quality of a program, i.e., a content obtained as stream data on the basis of genre information about contents included therein.

The image processing apparatus 11 includes a stream retrieval unit 21, a stream holding unit 22, an information separation unit 23, a decoding unit 24, an image processing unit 25, and, an image output unit 26.

The stream retrieval unit 21 retrieves stream data of a program, i.e., a content, obtained and received by a tuner, not shown, as a broadcast wave, and stores the retrieved stream data to the stream holding unit 22. The stream holding unit 22 temporarily holds the stream data of the program, and outputs the stream data to the information separation unit 23.

The information separation unit 23 separates title information such as EPG (Electronic Program Guide) and image data (including audio data) of the program, i.e., the content, included in the stream data output from the stream holding unit 22, and respectively provides them to the image processing unit 25 and the decoding unit 24. For example, the title information is information including genre information and recording mode about image data.

The decoding unit 24 decodes image data, and outputs baseband image data, i.e., a decoded result, to the image processing unit 25. At this occasion, decoded information about image data, i.e., a decoded result, is provided to the image processing unit 25. For example, the decoded information includes codec information and information about an image size.

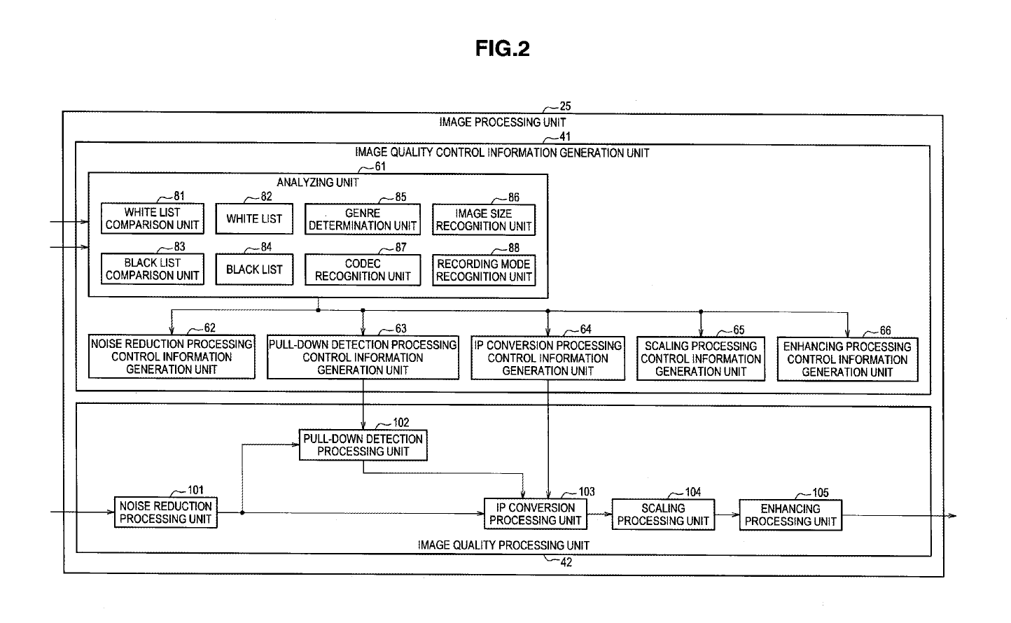

The image processing unit 25 improves the image quality of image data provided by the decoding unit 24 on the basis of the title information provided by the information separation unit 23 and the decoded information provided by the decoding unit 24, and outputs the image data to the image output unit 26. The configuration of the image processing unit 25 will be explained later in detail with reference to FIG. 2.

The image output unit 26 outputs the high-quality image provided by the image processing unit 25 to a display unit constituted by an LCD (Liquid Crystal Display), not shown, so that the image is displayed thereon.

### Example of Configuration of Image Processing Unit

Subsequently, an example of a configuration of the image processing unit 25 will be explained in detail with reference to FIG. 2.

The image processing unit 25 includes an image quality control information generation unit 41 and an image quality processing unit 42. The image quality control information generation unit 41 generates various kinds of image quality control information, and provides the generated image quality control information to the image quality processing unit 42. The image quality control information is necessary when the image quality processing unit 42 improves the image quality of the baseband image data. The image quality processing unit 42 improves the image quality of the image data on the basis of the image quality control information.

More specifically, the image quality control information generation unit 41 includes an analyzing unit 61, a noise reduction processing control information generation unit 62, a pull-down detection processing control information generation unit 63, an IP conversion processing control information generation unit 64, a scaling processing control information generation unit 65, and an enhancing processing control information generation unit 66. On the other hand, the image quality processing unit 42 includes a noise reduction processing unit 101, a pull-down detection processing unit 102, an IP conversion processing unit 103, a scaling processing unit 104, and an enhancing processing unit 105.

The analyzing unit 61 analyzes the genre information, the codec information, the image size, and the recording mode of the content of the image data to be processed, on the basis of the title information provided by the information separation unit 23 and the decoded information provided by the decoding unit 24. Then, the analyzing unit 61 provides the analysis result including the genre information, the codec information, the image size, and the recording mode to the noise reduction processing control information generation unit 62, the pull-down detection processing control information generation unit 63, the IP conversion processing control information generation unit 64, the scaling processing control information generation unit 65, and the enhancing processing control information generation unit 66.

More specifically, the analyzing unit 61 includes a white list comparison unit 81, a white list 82, a black list comparison unit 83, a black list 84, a genre determination unit 85, an image size recognition unit 86, a codec recognition unit 87, and a recording mode recognition unit 88. The genre determination unit 85 extracts the genre information from the title information. At this occasion, when a plurality of pieces of genre information can be extracted, the genre determination unit 85 extracts all the plurality of pieces of genre information included in the title information.

The white list comparison unit 81 compares the extracted genre information with genre information registered in the white list 82 to find matching genre information. For each genre, the white list 82 stores genre information that may be identified as the genre. The black list comparison unit 83 compares the extracted genre information with genre information registered in the black list 84 to find matching genre information. For each genre, the black list 84 stores genre information that is not to be identified as the genre. Then, the genre determination unit 85 determines the genre information about the content, i.e., the program of the image data to be processed, from the comparison search result of the white list comparison unit 81 and the comparison search result of the black list comparison unit 83.

At this occasion, when the genre determination unit 85 determines that the comparison search result of the white list comparison unit 81 does not match the comparison search result of the black list comparison unit 83, the genre determination unit 85 adopts the genre in the white list comparison search result as the genre of the program, i.e., the content to be processed. On the other hand, when the comparison search result of the black list comparison unit 83 includes items matching the comparison search result of the white list comparison unit 81, the genre determination unit 85 deems that it is difficult to identify the genre of the program, i.e., the content to be processed, and adopts information indicating that the genre may not be identified as information about the genre of the program, i.e., the content to be processed. In other words, the information about the genre of the program extracted from the title information by the genre determination unit 85 includes not only the information about the identified genre but also the information indicating that the genre may not be identified.

The image size recognition unit 86 obtains information indicating the image size included in the title information, and recognizes the image size of the image of the content to be processed. The codec recognition unit 87 recognizes the type of the codec from the decoded information provided from the decoding unit 24. The recording mode recognition unit 88 recognizes the recording mode included in the title information.

The noise reduction processing control information generation unit 62 generates the noise reduction processing control information on the basis of the genre information, the codec information, the image size, and the bit rate of the content of the image data. The noise reduction processing control information represents the intensity of the noise reduction processing in the noise reduction processing unit 101. Then, the noise reduction processing control information generation unit 62 provides the generated noise reduction processing control information to the noise reduction processing unit 101. The noise reduction processing unit 101 performs the noise reduction processing on the image of the image data on the basis of the noise reduction processing control information, and provides the processing result to the pull-down detection processing unit 102 and the IP conversion processing unit 103. As to the detailed configuration of the noise reduction processing unit 101, please see Japanese Patent Application Laid-Open No. 2008-311951, for example.

The pull-down detection processing control information generation unit 63 generates pull-down processing control information on the basis of the genre information, the codec information, the image size, and the bit rate of the content of the image data. The pull-down processing control information represents a pull-down pattern serving as a candidate for the pull-down detection processing unit 102. Then, the pull-down detection processing control information generation unit 63 provides the generated pull-down detection processing control information to the pull-down detection processing unit 102. The pull-down detection processing unit 102 executes the pull-down detection processing on the image of the image data on the basis of the pull-down detection processing control information, and provides pull-down information to the IP conversion processing unit 103. The pull-down information represents a pull-down pattern, i.e., a processing result. As to the detailed configuration of the pull-down detection processing unit 102, please see Japanese Patent Application Laid-Open No. 2009-065630, for example.

The IP conversion processing control information generation unit 64 generates IP conversion processing control information on the basis of the genre information, the codec information, the image size, and the bit rate of the content of the image data. The IP conversion processing control information includes a parameter representing whether the IP conversion processing unit 103 inversely transforms the image with the pull-down pattern detected by the pull-down detection processing unit 102 and thereafter performs IP conversion or the IP conversion processing unit 103 performs the IP conversion without the inverse transformation. Then, the IP conversion processing control information generation unit 64 provides the generated IP conversion processing control information to the IP conversion processing unit 103. On the basis of the IP conversion processing control information, the IP conversion processing unit 103 inversely transforms the image of the image data using the pull-down information and thereafter performs the IP conversion processing or performs the IP conversion processing without the inverse transformation, and provides the processing result to the scaling processing unit 104.

The scaling processing control information generation unit 65 generates scaling processing control information on the basis of the genre information, the codec information, the image size, and the bit rate of the content of the image data. The scaling processing control information includes a threshold value used when setting a pixel used when a pixel in question is interpolated/generated in the scaling processing. More specifically, the scaling processing control information generation unit 65 generates scaling processing control information. The scaling processing control information represents a threshold value of a reliability evaluation value set for each edge direction when detecting an edge direction of a pixel in question as an adjacent direction of a pixel used for interpolation/generation of the pixel in question with respect to the pixel in question. Then, the scaling processing control information generation unit 65 provides the generated scaling processing control information to the scaling processing unit 104. When the pixel in question is interpolated/generated, the scaling processing unit 104 calculates the reliability evaluation value for each edge direction of the pixel in question on the basis of the scaling processing control information, and interpolates/generates the pixel in question using information about a pixel adjacent to the pixel in question in an edge direction having a reliability evaluation value higher than the threshold value. Then, the scaling processing unit 104 executes the scaling processing by repeating the above interpolation/generation processing of pixels, and provides the processing result to the enhancing processing unit 105. As to the detailed configuration of the scaling processing unit 104, please see Japanese Patent Application Laid-Open No. 2006-155179, for example.

The enhancing processing control information generation unit 66 generates enhancing processing control information on the basis of the genre information, the codec information, the image size, and the bit rate of the content of the image data. The enhancing processing control information represents the intensity of enhancing processing in the enhancing processing unit 105. Then, the enhancing processing control information generation unit 66 provides the generated enhancing processing control information to the enhancing processing unit 105. The enhancing processing unit 105 executes the enhancing processing on the image of the image data on the basis of the enhancing processing control information, and provides the processing result to the image output unit 26. As to the detailed configuration of the enhancing processing unit 105, please see Japanese Patent Application Laid-Open No. 2007-213125, for example.

### [Image Processing]

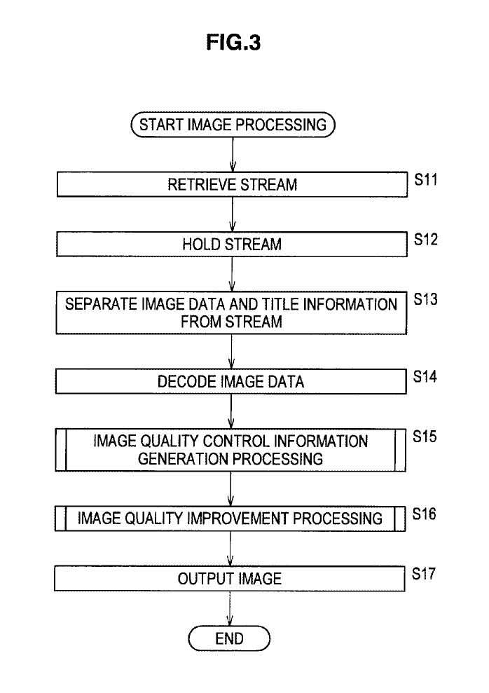

Subsequently, image processing will be explained with reference to the flowchart of FIG. 3.

In step S11, the stream retrieval unit 21 retrieves stream data, and provides the stream data to the stream holding unit 22.

In step S12, the stream holding unit 22 temporarily stores the stream data provided from the stream retrieval unit 21, and provides the stored stream data to the information separation unit 23 at a predetermined timing.

In step S13, the information separation unit 23 separates title information such as EPG (Electronic Program Guide) and image data (including audio data) of the program, i.e., the content, included in the stream data output from the stream holding unit 22, and respectively provides them to the image processing unit 25 and the decoding unit 24.

In step S14, the decoding unit 24 decodes image data, and outputs baseband image data, i.e., a decoded result, to the image processing unit 25. At this occasion, decoded information about image data, i.e., a decoded result, is provided to the image processing unit 25. For example, the decoded information includes information about codec information and an image size.

In step S15, the image quality control information generation unit 41 of the image processing unit 25 executes the image quality control information generation processing to generate image quality control information, and provides the generated image quality control information to the image quality processing unit 42.

### [Image Quality Control Information Generation Processing]

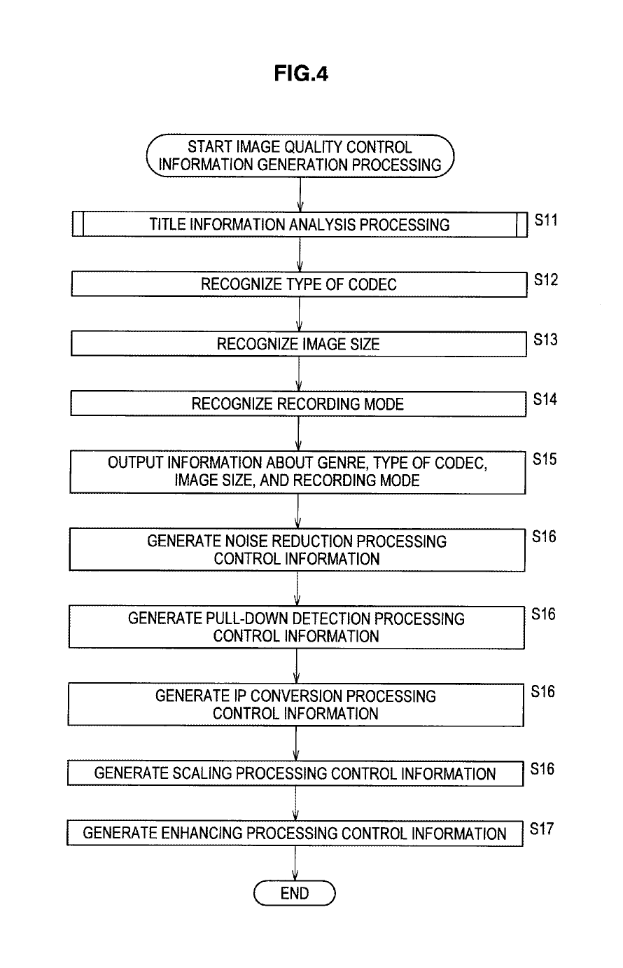

Image quality control information generation processing will be explained with reference to the flowchart of FIG. 4.

In step S31, the analyzing unit 61 executes the analysis processing on the basis of the title information and the decoded information, thus analyzing the genre information, the codec information, the image size, and the bit rate of the content of the image data.

### [Analysis Processing]

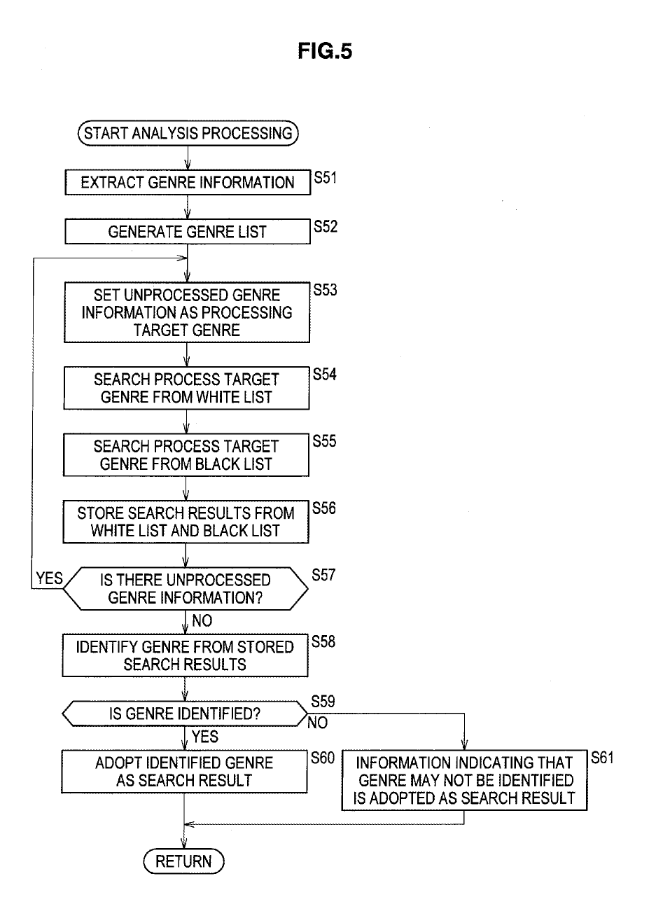

Analysis processing will be explained with reference to the flowchart of FIG. 5.

In step S51, the genre determination unit 85 of the analyzing unit 61 extracts the genre information about the content of which image data are to be processed included in the title information. The genre information is constituted by a genre code for distinguishing a genre. The genre code also includes information for indicating the genre code. For this reason, the genre determination unit 85 successively searches and extracts genre codes including information for indicating the genre codes.

In step S52, the genre determination unit 85 makes the extracted genre information into a genre list. In other words, the genre determination unit 85 generates the genre list including the genre codes successively extracted.

In step S53, the genre determination unit 85 sets unprocessed pieces of genre information in the genre list as processing target genres.

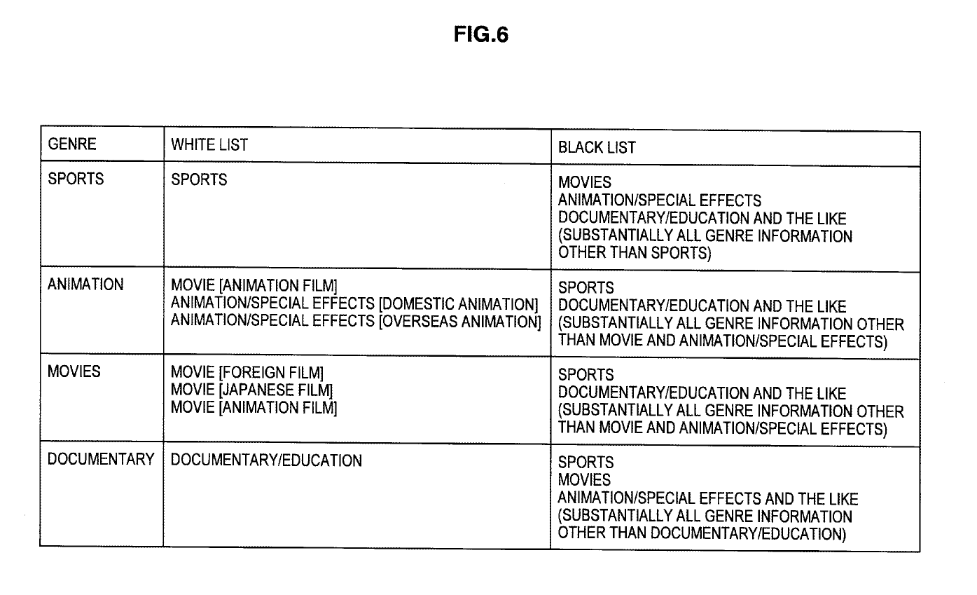

In step S54, the white list comparison unit 81 compares the processing target genre information with genre information registered in the white list 82 in advance to find matching genre information. In other words, the white list is what is shown in FIG. 6, for example. The white list is a list made from genre information classified into genres registered in advance. In FIG. 6, in the left portion, the genre information is defined as an item. The central portion is an example of the white list 82 registered in advance in association with the respective pieces of genre information. The right portion is an example of the black list 84.

More specifically, in the white list 82 of FIG. 6, examples of genres include “sports”, “animation”, “movie”, and “documentary” in this order. The white list 82 of FIG. 6 includes genre information, “sports”, as a genre of “sports”. In other words, when the extracted genre information is “sports”, this means that the genre of the content is “sports”.

In the white list 82 of FIG. 6, the genres of “animation” include genre information about “movie [animation film]”, “animation/special effects [domestic animation]”, and “animation/special effects [overseas animation]”. In other words, when the genre information is “movie [animation film]”, “animation/special effects [domestic animation]”, or “animation/special effects [overseas animation]”, this means that the genre of the content is “animation”.

In the white list 82 of FIG. 6, the genres of “movie” include genre information about “movie [Japanese film]”, “movie [foreign film]”, and “movie [animation film]”. In other words, when the genre information is “movie [Japanese film]”, “movie [foreign film]”, and “movie [animation film]”, this means that the genre of the content is “movie”.

In the white list 82 of FIG. 6, the genres of “documentary” include genre information about “documentary/education”. In other words, when the genre information is “documentary/education”, this means that the genre of the content is “documentary”.

In step S55, the black list comparison unit 83 compares the processing target genre information with genre information registered in the black list 84 in advance to find matching genre information. In other words, the black list 84 is what is shown in FIG. 6, for example. The black list is a list made from genre information that is not classified into genres registered in advance. More specifically, the black list 84 is substantially all the genre information other than the genre information registered in the white list 82 for each genre.

More specifically, in the black list 84 of FIG. 6, genres of “sports” include substantially all the genre information except “sports” such as “movie”, “animation/special effects”, and “documentary/education”. In other words, when the extracted genre information is substantially all the genre information except “sports” such as “movie”, “animation/special effects”, and “documentary/education”, this means that the genre of the content is not “sports”.

In the black list 84 of FIG. 6, genres of “animation” include substantially all the genre information except “animation” such as “sports” and “documentary/education”. In other words, when the genre information is substantially all the genre information except “movie” and “animation/special effects” such as “sports” and “documentary/education”, this means that the genre of the content is not “animation”.

In the black list 84 of FIG. 6, genres of “movie” include substantially all the genre information except “movie ” and “animation/special effects ” such as “sports” and “documentary/education”. In other words, when the genre information is substantially all the genre information except “movie” and “animation/special effects” such as “sports” and “documentary/education”, this means that the genre of the content is not “movie”.

In the black list 84 of FIG. 6, genres of “documentary” include substantially all the genre information except “documentary/education” such as “sports”, “movie”, and “animation/special effects”. In other words, when the genre information is substantially all the genre information except “documentary/education” such as “sports”, “movie”, and “animation/special effects”, this means that the genre of the content is not “documentary”.

In step S56, the genre determination unit 85 stores the comparison search result of the white list comparison unit 81 and the black list comparison unit 83.

In step S57, the genre determination unit 85 determines whether the genre list includes any unprocessed genre information. When the genre list is determined to include unprocessed genre information, the flow returns to step S53. In other words, the processings in steps S53 to S57 are repeated until all the genre information registered in the genre list is compared with the genre information registered in the white list 82 and the black list 84. Then, in step S57, when the genre list is determined to include no unprocessed genre information, step S58 is subsequently performed.

In step S58, the genre determination unit 85 identifies the genre of the content identified by the genre information on the basis of the stored comparison search result of the white list comparison unit 81 and the black list comparison unit 83. For example, when the genre information is “sports”, the comparison search result based on the white list 82 includes the genre “sports” as the comparison search result. On the other hand, when the genre information is “sports”, the comparison search result based on the black list 84 includes all the other genres other than “sports” as the comparison search result. As described above, when the genre in the comparison search result based on the white list 82 does not match the genre in the comparison search result based on the black list 84, the genre determination unit 85 adopts the genre in the search result based on the white list 82 as the genre of the content.

On the other hand, when the extracted genre information includes “sports” and “movie [animation film]”, the genres in the comparison search result based on the white list 82 include “sports” and “animation”. When the genre information is “sports”, all the genres other than “sports” are searched in the comparison search result based on the black list 84 . When the genre information is “movie [animation film]”, all the genres other than “animation” are searched in the comparison search result based on the black list 84. In other words, when these are combined, the comparison search results based on the black list 84 include all the genres. Therefore, the genres in the comparison search result based on the white list 82 are included in the genres in the comparison search result based on the black list 84. In this case, therefore, the genre determination unit 85 may not identify the genre of the content.

In step S59, the genre determination unit 85 determines whether the genre of the program, i.e., the content, can be identified or not on the basis of the title information. In other words, the genre determination unit 85 determines whether the genre of the program, i.e., the content, can be identified or not in the processing of step S58 as explained above.

When it is determined that, for example, the genre can be identified in step S59, the genre determination unit 85 adopts the identified genre as the search result based on the title information in step S60.

On the other hand, when it is determined that, for example, the genre may not be identified in step S59, the genre determination unit 85 adopts information indicating that the genre of the content may not be identified as the search result based on the title information in step S61.

With the above processing, not only the genre to be searched but also the genre not to be searched is found in the comparison/search with the white list 82 and the black list 84 based on the genre information, and the genre is identified by combining these search results. Therefore, the genre of the program, i.e., the content of the image data to be processed, can be accurately detected. Therefore, when it is difficult to narrow down the genres of a program into one genre, the information indicating that the genre may not be identified can be adopted as the search result, and this prevents inappropriate image quality improvement processing performed on images of a program that is classified into a plurality of genres. This reduces errors caused by the image quality improvement processing.

Now, we will get back to the explanation about the flowchart in FIG. 4.

When the genre of the program, i.e., the content including the image data to be processed, is identified in the processing of step S31, step S32 is subsequently performed.

In step S32, the codec recognition unit 87 recognizes, on the basis of the decoded information, the type of the codec of the decoded baseband image data, such as AVC (Advanced Video Coding) and MPEG (Moving Picture Experts Group).

In step S33, the image size recognition unit 86 recognizes the image size of the decoded baseband image data on the basis of the decoded information.

In step S34, the recording mode recognition unit 88 recognizes the recording mode of the image data on the basis of the title information.

In step S35, the analyzing unit 61 outputs information about the genre determined by the genre determination unit 85, the image size recognized by the image size recognition unit 86, the type of the codec recognized by the codec recognition unit 87, and the recording mode recognized by the recording mode recognition unit 88. The above information about the genre, the image size, the type of the codec, and the recording mode is respectively provided to the noise reduction processing control information generation unit 62, the pull-down detection processing control information generation unit 63, the IP conversion processing control information generation unit 64, the scaling processing control information generation unit 65, and the enhancing processing control information generation unit 66.

In step S36, the noise reduction processing control information generation unit 62 generates noise reduction processing control information on the basis of the information about the genre, the image size, the type of the codec, and the recording mode, and provides the noise reduction processing control information to the noise reduction processing unit 101. The noise reduction processing control information includes parameters for controlling filter characteristics, which are used by the noise reduction processing unit 101.

In other words, for example, when the genre is “animation”, the image includes many contour lines, and accordingly, the noise reduction processing control information generation unit 62 generates noise reduction processing control information including parameters representing such filter characteristic that the intensity of the noise reduction processing performed by the noise reduction processing unit 101 is set at a high level. Therefore, the image in the program whose genre is classified into “animation” can be made into a better image quality with as little noise as possible. When the genre is “sports”, the noise reduction processing control information generation unit 62 generates noise reduction processing control information including parameters representing such filter characteristic that the intensity of the noise reduction processing performed by the noise reduction processing unit 101 is set at a low level. Therefore, occurrence of processing errors such as trail-like noise can be reduced. Further, the noise reduction processing control information generation unit 62 estimates the noise level included in the image data such as the type of codec and the recording mode, and generates, as noise reduction processing control information, parameters representing such filter characteristics that the intensity of the noise reduction processing is at a level corresponding to the estimated noise level. Further, when there is the information indicating that the genre may not be identified, the noise reduction processing control information generation unit 62 generates, as noise reduction processing control information, parameters representing such filter characteristics that the intensity of the noise reduction processing is at such a noise level that does not affect the genre.

In step S37, the pull-down detection processing control information generation unit 63 generates pull-down detection processing control information on the basis of the information about the genre, the image size, the type of codec, and the recording mode, and provides the pull-down detection processing control information to the pull-down detection unit 102. The pull-down detection processing control information is used to limit a pull-down pattern to be detected by the pull-down detection processing unit 102. In other words, the pull-down detection processing unit 102 detects, from the image data, the pull-down pattern limited on the basis of the pull-down detection processing control information, and provides the detection result as the pull-down detection processing control information to the IP conversion processing unit 103.

In other words, the pull-down detection processing unit 102 performs cadence detection to detect the pull-down pattern by checking all the possible patterns, but the used pull-down patterns are somewhat identified according to the genre, and this provides a filter to the detection processing for the pull-down pattern. For example, when the image data have the genre “animation”, the used pull-down pattern is usually 2:3, 5:5, or 8:7. Therefore, the pull-down detection processing control information generation unit 63 generates, as the pull-down detection processing control information, information for identifying the pull-down pattern identified by the genre, and provides the pull-down detection processing control information to the pull-down detection processing unit 102.

In step S38, the IP conversion processing control information generation unit 64 generates IP conversion processing control information on the basis of the information about the genre, the image size, the type of codec, and the recording mode. The IP conversion processing control information represents whether the IP conversion processing unit 103 performs inverse transformation with the pull-down pattern provided from the pull-down detection processing unit 102 or not. Then, the IP conversion processing control information generation unit 64 provides the generated IP conversion processing control information to the IP conversion processing unit 103.

Therefore, for example, from image data in a genre “sports”, e.g., images in a program almost all of which is made with 60 Hz images, the pull-down pattern is detected on the basis of the amount of difference between frames. Even if, at this occasion, the amount of difference attains a value almost close to that of the pull-down pattern of image data in the program in the genre “animation”, the image data in a genre “sports” can be treated as 60 Hz images.

For example, when the genre is “animation”, the IP conversion processing unit 103 performs inverse transformation on the basis of the pull-down pattern detected by the pull-down detection processing unit 102 on the basis of the IP conversion processing control information, and executes the IP conversion processing, whereby the image quality can be improved. On the other hand, when the genre is “sports”, even if the pull-down pattern is detected by the pull-down detection processing unit 102 on the basis of the IP conversion processing control information, the IP conversion processing unit 103 can execute the IP conversion processing without performing the inverse transformation on the basis of the detected pull-down pattern. Alternatively, when the genre may not be identified, the IP conversion processing control information is set to information indicating that the detection processing is to be performed with all the default pull-down patterns. Therefore, the IP conversion processing unit 103 performs inverse transformation on the basis of the pull-down pattern detected by the pull-down detection processing unit 102, and thereafter executes the IP conversion processing.

As a result, the IP conversion processing can be appropriately achieved according to the genre.

In step S39, the scaling processing control information generation unit 65 generates scaling processing control information on the basis of the genre, the image size, the type of codec, and the recording mode. The scaling processing control information is a threshold value of a reliability evaluation value used in the edge directionality analysis when the scaling processing unit 104 performs interpolation processing based on edge directions in the image. Then, the scaling processing control information generation unit 65 provides the generated scaling processing control information to the scaling processing unit 104.

In other words, the scaling processing unit 104 calculates the reliability evaluation value for each edge direction when the edge direction in the image is analyzed. For example, when the genre is “animation”, the image quality is not much deteriorated and the amount of noise is reduced as a result of the noise reduction processing and the IP conversion processing, and therefore, the edge directionality detection is considered to be relatively easy and reliable. For this reason, the scaling processing control information generation unit 65 generates scaling processing control information for setting a low (weaker) threshold value used for the reliability evaluation value thereof, and provides the generated scaling processing control information to the scaling processing unit 104.

For example, when the genre is “sports”, the image quality is deteriorated at a relatively high level and the amount of noise is relatively large as a result of the noise reduction processing and the IP conversion processing, and therefore, the edge directionality detection is considered to be relatively not easy and unreliable. For this reason, the scaling processing control information generation unit 65 generates scaling processing control information for setting a high (stronger) threshold value used for the reliability evaluation value thereof, and provides the generated scaling processing control information to the scaling processing unit 104. When the genre may not be identified, the reliability of the reliability evaluation value for each edge direction may be low. In this case, the scaling processing control information generation unit 65 generates scaling processing control information for setting a high (stronger) threshold value used for the reliability evaluation value thereof.

As a result, the edge direction can be appropriately calculated. Therefore, an interpolated/generated pixel in question can be appropriately calculated using the pixel adjacent to the pixel in question in the appropriate edge direction.

In step S40, the enhancing processing control information generation unit 66 sets the intensity of the enhancing processing on the basis of the genre, the image size, the type of codec, and the recording mode, and provides the setting information as the enhancing processing control information to the enhancing processing unit 105. In other words, for example, when the genre is “animation”, the noise is removed and image quality deterioration is reduced as a result of the noise reduction processing and the IP conversion processing. Accordingly, the noise and the image deterioration are considered to be inconspicuous. Therefore, the enhancing processing control information generation unit 66 generates enhancing processing control information so as to increase the intensity of the enhancing processing. On the other hand, for example, when the genre is “sports”, the noise is not sufficiently removed and image quality deterioration is expected as a result of the noise reduction processing and the IP conversion processing. Therefore, the enhancing processing control information generation unit 66 generates enhancing processing control information so as to reduce the intensity of the enhancing processing. Further, when the genre is not identified, there is a possibility that the image from which the noise is not reduced is handled. Therefore, the enhancing processing control information generation unit 66 generates enhancing processing control information in which the intensity of the enhancing processing is set at a low level.

As a result, this processing can increase the intensity of the enhancing processing performed on the image from which the noise is reduced and whose image quality is deteriorated, thus increasing the image quality thereof. On the other hand, this processing can reduce the intensity of the enhancing processing performed on the image from which the noise is not reduced and whose image quality is expected to be deteriorated, and this reduces such enhancing processing in which the noise and the image quality deterioration are conspicuous.

Since the processing is performed as above, the intensities of the noise reduction processing performed by the noise reduction processing unit 101, the pull-down detection processing performed by the pull-down detection processing unit 102, the IP conversion processing performed by the IP conversion processing unit 103, the scaling processing performed by the scaling processing unit 104, and the enhancing processing performed by the enhancing processing unit 105 are set at appropriate levels on the basis of the genre, the image size, the type of codec, and the recording mode. As a result, the image quality improvement processing appropriate for the image in the program to be processed can be achieved.

Now, we will get back to the explanation about the flowchart in FIG. 3.

In step S15, the image quality control information generation unit 41 generates the image quality control information including the noise reduction processing control information, the pull-down detection processing control information, the IP conversion processing control information, the scaling processing control information, and the enhancing processing control information, and provides each of them to the image quality processing unit 42.

In step S16, the image quality processing unit 42 executes the image quality improvement processing on the basis of the image quality control information provided by the image quality control information generation unit 41, and improves the image quality of the image of the image data provided by the decoding unit 24. Then, the image is provided to the image output unit 26.

In step S17, the image output unit 26 outputs the high-quality image provided by the image quality processing unit 42 to a display unit, not shown, and the image is displayed on the display unit.

### [Image Quality Improvement Processing]

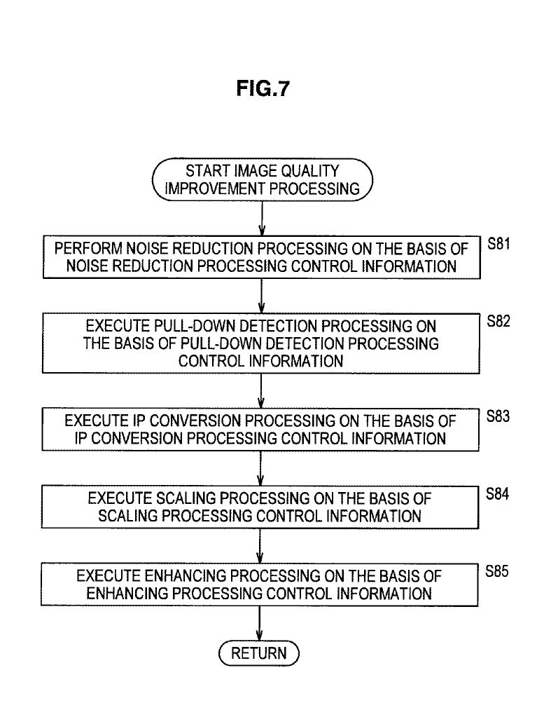

In this case, the image quality improvement processing in step S16 will be explained with reference to the flowchart in FIG. 7.

In step S81, the noise reduction processing unit 101 executes the noise reduction processing with the filter processing having the characteristics set by the parameters based on the noise reduction processing control information provided by the noise reduction processing control information generation unit 62, and removes the noise from the image. Then, the noise reduction processing unit 101 provides the image data from which the noise is removed to the pull-down detection processing unit 102 and the IP conversion processing unit 103.

In step S82, the pull-down detection processing unit 102 detects, from the image from which the noise is removed, the pull-down pattern limited on the basis of the pull-down detection processing control information provided by the pull-down detection processing control information generation unit 63. Then, the pull-down detection processing unit 102 generates a pull-down detection processing control signal including the information about the detected pull-down pattern, and provides the pull-down detection processing control signal to the IP conversion processing unit 103.

In step S83, the IP conversion processing unit 103 determines whether the inverse transformation is performed with the pull-down pattern provided from the pull-down detection processing unit 102, on the basis of the IP conversion processing control information provided by the IP conversion processing control information generation unit 64. Then, when the IP conversion processing control information indicates that the inverse transformation is performed with the pull-down pattern, the IP conversion processing unit 103 inversely transforms the noise-reduced image data with the pull-down pattern provided by the pull-down detection processing unit 102, and thereafter, performs the IP conversion processing on the image data. The obtained image dare are provided to the scaling processing unit 104. On the other hand, when the IP conversion processing control information indicates that the inverse transformation is not performed with the pull-down pattern, the IP conversion processing unit 103 performs the IP conversion processing on the noise-reduced image data without performing the inverse transformation with the pull-down pattern, and provides the obtained image data to the scaling processing unit 104.

In step S84, the scaling processing unit 104 evaluates the reliability of the edge direction using the threshold value of the intensity based on the scaling processing control information provided from the scaling processing control information generation unit 65, and detects the edge direction on the basis of the evaluation result. Then, the scaling processing unit 104 generates interpolation pixels using the detected pixels adjacent in the edge directions, performs the scaling processing on the IP-converted image data, and provides it to the enhancing processing unit 105.

In step S85, the enhancing processing unit 105 performs the enhancing processing on the scaled image on the basis of the intensity based on the enhancing processing control information provided by the enhancing processing control information generation unit 66, and outputs the image to the image output unit 26.

Since the processing is performed as above, the noise reduction processing, the pull-down detection processing, the IP conversion processing, scaling processing, and the enhancing processing are appropriately performed on the basis of the genre, the image size, the type of codec, and the recording mode, whereby the image quality of the image data can be improved.

In summary, the following image quality improvement processing can be performed. In other words, for example, when the genre of the program of the image data to be processed is “animation”, the noise reduction processing is set at a high level, the scaling processing is set at a high level, and the enhancing processing is set at a high level. With the above settings, the image can be converted to have such an image quality in which contour lines are shown clearly without emphasizing noise. Therefore, the image quality of the image in the genre “animation” can be appropriately improved.

For example, when the genre is “movie”, the noise reduction processing is set at a low level, the scaling processing is set at a low level, and the enhancing processing is set at a low level. As a result, the image is converted to have such an image quality in which noise peculiar to movie films (grain noise) is preserved, so that the image quality can be appropriately improved while preserving the original taste of the image quality of the movies.

Further, for example, when the genre is “sports”, the noise reduction processing is set at a low level, the scaling processing is set at a low level, and the enhancing processing is turned off (no enhancing processing is performed). Therefore, since the noise reduction is not set at a high level, there is no disruption, and the enhancing processing is not performed. Therefore, the image can be converted to have such an image quality in which noise is not emphasized. As a result, noise reduction is not strongly applied to a fast-moving image, so that the image is not blurred, and the noise is not emphasized by the enhancing processing. Therefore, the image quality can be appropriately improved.

For example, when the genre is “documentary”, the noise reduction processing is set at about a medium level, the scaling processing is set at a medium level, and the enhancing processing is set at a medium level. This moderately reduces noise level, and the image is converted to have an image quality in which the scaling processing and the enhancing processing are moderately applied. Therefore, the noise is appropriately reduced, and in addition the effect of the scaling processing and the enhancing processing, the image qualities of natural images, landscape images, and the like can be appropriately improved.

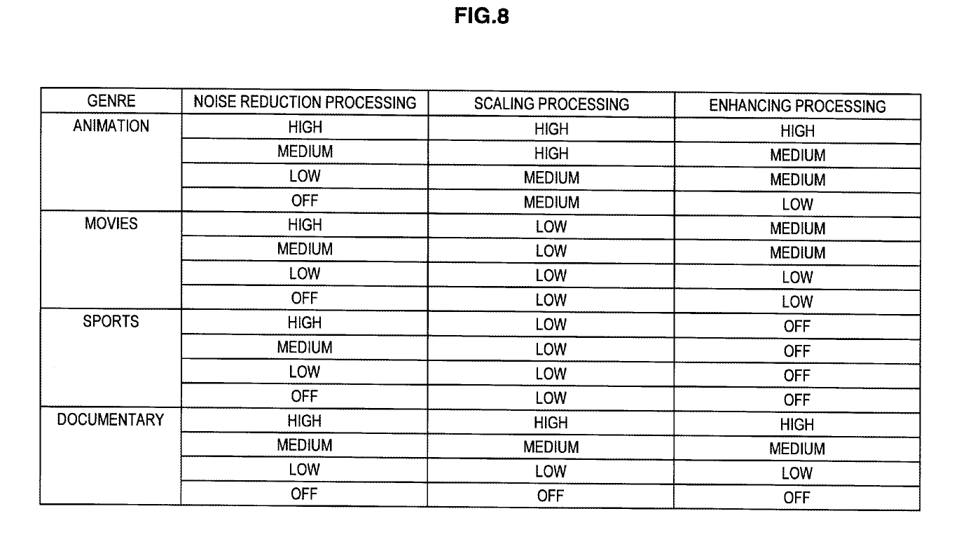

Further, when the genre is “animation”, the scaling processing and the enhancing processing may be controlled in accordance with the intensity of the noise reduction processing. In other words, for example, when the intensity of the noise reduction processing is set at a medium level as shown in FIG. 8, the scaling processing is strongly affected, and the noise still remains . Therefore, the enhancing processing may be set at about a medium level. For example, when the intensity of the noise reduction processing is set at a low level as shown in FIG. 8, the scaling processing is set at about a medium level in view of the influence. Since the noise still remains, the enhancing processing may be set at about a medium level. Further, for example, when the intensity of the noise reduction processing is turned off (no noise reduction processing is performed) as shown in FIG. 8, the scaling is set at a low level in view of the influence. Since the noise still remains, the enhancing processing may be set at a low level.

When the genre is “movie”, the scaling processing and the enhancing processing may be controlled in accordance with the intensity of the noise reduction processing. In other words, for example, when the intensity of the noise reduction processing is set at a high level as shown in FIG. 8, the scaling processing is not so much affected, and accordingly, it is set at a low level. Since the noise still remains, the enhancing processing may be set at about a medium level. For example, when the intensity of the noise reduction processing is set at about a medium level as shown in FIG. 8, the scaling processing is set at a low level in view of the influence. In this case, since the noise still remains, the enhancing processing may be set at a low level. Further, for example, when the intensity of the noise reduction processing is turned off (no noise reduction processing is performed) as shown in FIG. 8, the scaling processing is set at a low level in view of the influence. Since the noise still remains, the enhancing processing may be set at a low level.

Further, when the genre is “sports”, the scaling processing and the enhancing processing may be controlled in accordance with the intensity of the noise reduction processing. In other words, for example, when the intensity of the noise reduction processing is set at a high level as shown in FIG. 8, the scaling processing is not so much affected, and accordingly, it is set at a low level. In this case, since the noise still remains, the enhancing processing may be set at about a medium level. For example, when the intensity of the noise reduction processing is set at about a medium level as shown in FIG. 8, the scaling processing is set at a low level in view of the influence. In this case, since the noise still remains, the enhancing processing may be set at a low level. Further, for example, when the intensity of the noise reduction processing is turned off (no noise reduction processing is performed) as shown in FIG. 8, the scaling processing is set at a low level in view of the influence. In this case, since the noise still remains, the enhancing processing may be set at a low level.

When the genre is “documentary”, the scaling processing and the enhancing processing may be controlled in accordance with the intensity of the noise reduction processing. In other words, for example, when the intensity of the noise reduction processing is set at a high level as shown in FIG. 8, the scaling processing is heavily affected, and accordingly, it is set at a high level. In this case, since the noise is removed, the enhancing processing may be set at a high level. For example, when the intensity of the noise reduction processing is set at a low level as shown in FIG. 8, the scaling processing is set at a low level in view of the influence. In this case, since the noise still remains, the enhancing processing may be set at a low level. Further, for example, when the noise reduction processing is turned off (no noise reduction processing is performed) as shown in FIG. 8, the scaling processing is turned off (no scaling processing is performed) in view of the influence. In this case, since the noise still remains, the enhancing processing may be turned off (no enhancing processing is performed).

Further, when the genre may not be identified, the image quality improvement processing corresponding to a particular genre is performed, and this may cause disruption in the image. Therefore, all of the noise reduction processing, the scaling processing, and the enhancing processing may be set at a low level or turned off, whereby the disruption of the image is prevented.

Since the processing is performed as above, the image quality improvement processing most suitable for an image can be achieved on the basis of the genre, the image size, the type of codec, and the recording mode.

By the way, the above series of processings may be performed by either hardware or software. When a series of processes is executed by software, a program constituting the software is installed from a recording medium to a computer incorporated into dedicated hardware, or, for example, a general-purpose personal computer capable of executing various kinds of functions by installing various kinds of programs.

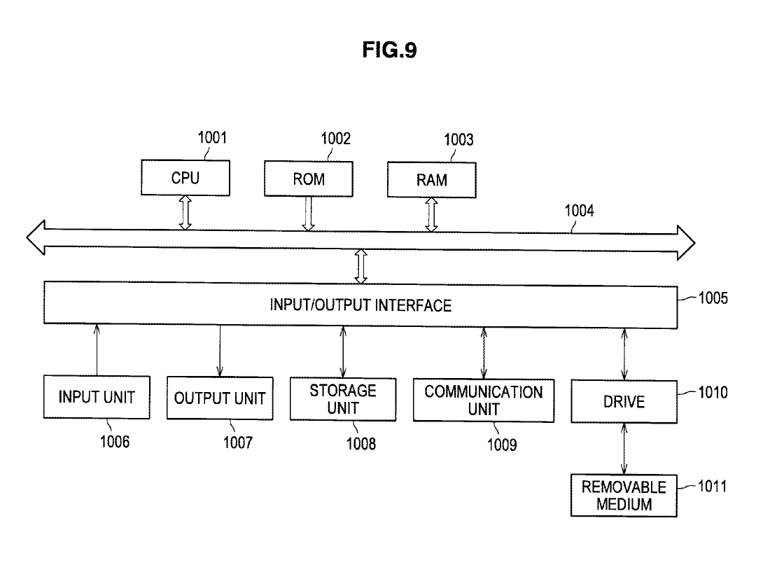

FIG. 9 illustrates an example of a configuration of a general-purpose personal computer. This personal computer has a CPU (Central Processing Unit) 1001 incorporated therein. The CPU 1001 is connected to an input/output interface 1005 via a bus 1004. The bus 1004 is connected to a ROM (Read Only Memory) 1002 and a RAM (Random Access Memory) 1003.

The input/output interface 1005 is connected to an input unit 1006 constituted by an input device such as a keyboard and a mouse with which a user inputs operation commands, an output unit 1007 for outputting processing operation screens and processing result images to a display device, a storage unit 1008 including a hard disk drive for storing programs and various kinds of data, and a communication unit 1009 made of a LAN (Local Area Network) adapter for executing communication processing via a network such as the Internet. A drive 1010 is connected to read/write data from/to a removable medium 1011 such as a magnetic disk (including a flexible disk), an optical disk (including a CD-ROM (Compact Disc-Read Only Memory), a DVD (Digital Versatile Disc)), a magneto-optical disk (including MD (Mini Disc)), and a semiconductor memory.

The CPU 1001 executes various kinds of processings in accordance with programs which are stored in the ROM 1002. Alternatively, the programs are read from the removable medium 1011 such as a magnetic disk, an optical disk, a magneto-optical disk, and a semiconductor memory, and the programs are installed to the storage unit 1008 and loaded from the storage until 1008 to the RAM 1003. The RAM 1003 stores data as necessary, which are used when the CPU 1001 executes various kinds of processings.

In this specification, steps describing programs recorded in a recording medium include the processings performed in time sequence according to the described order. The steps is not necessarily performed in time sequence, and the steps include the processings executed in parallel or individually.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2010-132455 filed in the Japan Patent Office on Jun. 9, 2010, the entire content of which is hereby incorporated by reference.

What is claimed is:

1. An image processing apparatus comprising:
a genre information retrieval section retrieving genre information about a program;
an image quality control signal generation section generating an image quality control signal for controlling image quality of an image in the program on the basis of the genre information retrieved by the genre information retrieval section; and
an image quality control section controlling the image quality of the image in the program on the basis of the image quality control signal generated by the image quality control signal generation section.

2. The image processing apparatus according to claim 1,
wherein the genre information retrieval section retrieves not only the genre information but also related data about the image in the program, and
the image quality control signal generation section generates the image quality control signal for controlling image quality of the image in the program on the basis of not only the genre information but also the related data about the image in the program retrieved by the genre information retrieval section.

3. The image processing apparatus according to claim 1,
wherein the image quality control signal generation section includes a noise reduction processing control signal generation section generating a noise reduction processing control signal representing an intensity of processing for removing noise on the basis of the genre information, and
the image quality control section includes a noise reduction processing section executing the processing for removing, at the intensity based on the noise reduction processing control signal, noise in the image quality of the image in the program.

4. The image processing apparatus according to claim 1,
wherein the image quality control signal generation section includes:
a pull-down detection processing control signal generation section generating a pull-down detection processing control signal for limiting a pull-down pattern to be detected, when the pull-down pattern is detected on the basis of the genre information from the image in the program; and
an IP conversion processing control signal generation section generating, on the basis of the genre information, an IP conversion processing control signal including a parameter indicating whether IP conversion is performed after inverse transformation is performed with the pull-down pattern of the image or the IP conversion is performed without performing the inverse transformation when IP conversion processing is performed on the image in the program, and
the image quality control section includes:
a pull-down detection processing section detecting the pull-down pattern of the image in the program using the pull-down pattern limited on the basis of the pull-down detection processing control signal; and
an IP conversion processing section performing the IP conversion on the image in the program without performing the inverse transformation or upon performing the inverse transformation on the image with the pull-down pattern detected by the pull-down detection processing section on the basis of the IP conversion processing control signal.

5. The image processing apparatus according to claim 1,
wherein the image quality control signal generation section includes a scaling processing control signal generation section generating, on the basis of the genre information, a scaling processing control signal for controlling a threshold value used for reliability evaluation of interpolation/generation of a pixel of the image in the program in an edge direction, and
the image quality control section includes a scaling processing section interpolating/generating, on the basis of the scaling processing control signal, a pixel in question using a pixel residing in an edge direction in which the reliability evaluation is higher than the threshold value from among edge directions of the image in the program.

6. The image processing apparatus according to claim 1,
wherein the image quality control signal generation section includes an enhancing processing control signal generation section generating, on the basis of the genre information, an enhancing processing control signal for controlling an intensity of the enhancing processing performed on the image in the program, and
the image quality control section includes an enhancing processing section performing enhancing processing on the image in the program at the intensity based on the enhancing processing control signal.

7. An image processing method for an image processing apparatus comprising:
a genre information retrieval section retrieving genre information about a program;
an image quality control signal generation section generating an image quality control signal for controlling image quality of an image in the program on the basis of the genre information retrieved by the genre information retrieval section; and
an image quality control section controlling the image quality of the image in the program on the basis of the image quality control signal generated by the image quality control signal generation section,
wherein the image processing method includes:
causing the genre information retrieval section to retrieve the genre information about the program;
causing the image quality control signal generation section to generate the image quality control signal for controlling the image quality of the image in the program on the basis of the genre information retrieved by the genre information retrieval section; and
causing the image quality control section to control the image quality of the image in the program on the basis of the image quality control signal generated by the image quality control signal generation section.

8. A program for a computer controlling an image processing apparatus comprising:
a genre information retrieval section retrieving genre information about a program;
an image quality control signal generation section generating an image quality control signal for controlling image quality of an image in the program on the basis of the genre information retrieved by the genre information retrieval section; and
an image quality control section controlling the image quality of the image in the program on the basis of the image quality control signal generated by the image quality control signal generation section,
wherein the program causes the computer to execute:
causing the genre information retrieval section to retrieve the genre information about the program;
causing the image quality control signal generation section to generate the image quality control signal for controlling the image quality of the image in the program on the basis of the genre information retrieved by the genre information retrieval section; and
causing the image quality control section to control the image quality of the image in the program on the basis of the image quality control signal generated by the image quality control signal generation section.
